(19) United States
(12) Patent Application Publication
(10) Pub. No.: US 2006/0149956 A1
(43) Pub. Date: Jul. 6, 2006

(54) Instant-on computer system and method for instantly booting a computer system

(75) Inventor: Wen Hua Chang, Taipei (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/272,368

(22) Filed: Nov. 10, 2005

(30) Foreign Application Priority Data
Dec. 31, 2004 (TW) TW93141736

(51) Int. Cl. G06F 15/177

(52) U.S. Cl. 713/1

(57) ABSTRACT

A method for instantly booting a computer system is provided. In an embodiment, a flag for activation of a first operating system or a second operating system of the computer system is defined. A quick key is enabled to activate the computer system. A BIOS of the computer system is activated. A boot manager is loaded and activated via the BIOS. The boot manager triggers a flag according to the quick key and activates the first operating system or the second operating system corresponding to a flag value.

### BACKGROUND

The invention relates to booting processes for computer systems, and more particularly, to booting processes for instant-on computer systems.

Instant-on technologies have widely applied to computer systems for instantly activating conventional computer systems, such as household appliances. Generally, computer systems capable of instant booting functions are called multimedia computer systems, that is, computer systems capable of video, audio, and household appliance functions, such that the computer systems can play music, movies, and TV programs or take music, films, and the like.

FIG. 1 is a flowchart of a conventional method for instantly booting a computer system. A computer system is first activated using a quick key (step S11). Next, a central processing unit (CPU) of the computer system loads required hardware information thereof through a basic input/output system (BIOS) thereof (step S12). A boot manager located in a boot disk is loaded into a storage medium storing the BIOS (step S13). The BIOS creates a boot menu comprising operating system options using the boot manager (step S14), obtains kernel codes of a selected operating system according to user input (step S15) and loads and executes the kernel codes for enabling a booting process of the selected operating system (step S16).

The above described booting processes comprise the following drawbacks. Different vendors design their BIOS according to their own rules, such that booting processes become complicated when boot managers are loaded. Additionally, the BIOS update is in high risk considering system securities, and the boot manager may be damaged when errors occur during the updating process.

Another method for booting a computer system is to execute a boot manager stored in a boot disk directly to create a boot menu but is not required to load the boot manager to the BIOS. Instant-on computer systems focus on “fast boot”, and it wastes time when a boot menu is displayed for user determination to load which operating system during a booting process, such that the “fast boot” cannot be achieved.

Thus, an improved method for instantly booting a computer system is desirable.

### SUMMARY

A method for instantly booting a computer system is provided. In an embodiment, a flag for activation of a first operating system or a second operating system of the computer system is defined. A quick key is enabled to activate the computer system. A BIOS of the computer system is activated. A boot manager is loaded and activated via the BIOS. The boot manager triggers a flag according to the quick key and activates the first operating system or the second operating system corresponding to a flag value.

An instant-on computer system is provided. The system of an embodiment comprises a BIOS, a first storage medium, a second storage medium, and a CPU. The BIOS activates corresponding hardware peripherals when a quick key is enabled. The first storage medium stores the BIOS. The second storage medium stores a boot manager, a first operating system, and a second operating system. The CPU loads and activates the boot manager via the BIOS and triggers a flag via the boot manager according to the quick key to activate the first operating system or the second operating system corresponding to a flag value

Another instant-on computer system is provided. The system of an embodiment comprises a BIOS, a first storage medium, a second storage medium, and a CPU. The BIOS activates corresponding hardware peripherals when a quick key is enabled. The first storage medium stores the BIOS. The second storage medium stores a boot manager and a first operating system. The third storage medium stores a second operating system. The CPU loads and activates the boot manager via the BIOS and triggers a flag via the boot manager according to the quick key to activate the first operating system or the second operating system corresponding to a flag value.

### BRIEF DESCRIPTION OF THE DRAWINGS

The present invention can be more fully understood by reading the subsequent detailed description and examples of embodiments thereof with reference made to the accompanying drawings, wherein:

FIG. 1 is a flowchart of a conventional method for instantly booting a computer system;

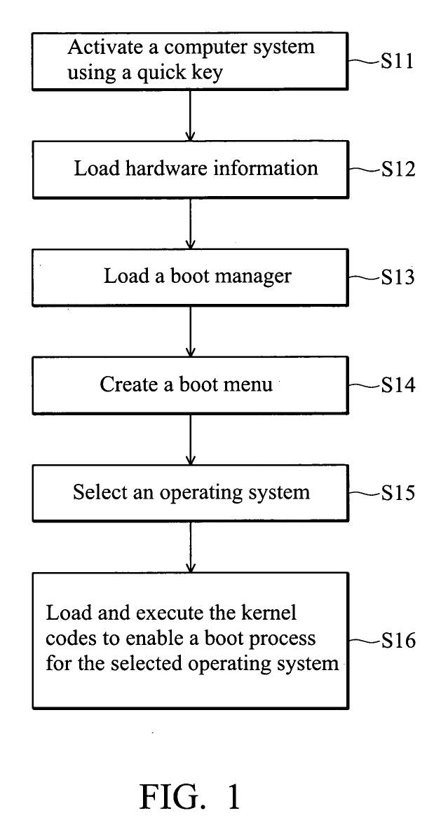

FIG. 2 is a schematic diagram of an embodiment of an instant-on computer system;

FIG. 3 is a schematic diagram of another embodiment of an instant-on computer system; and

FIG. 4 is a flowchart of an embodiment of a method for instantly booting a computer system.

### DETAILED DESCRIPTION

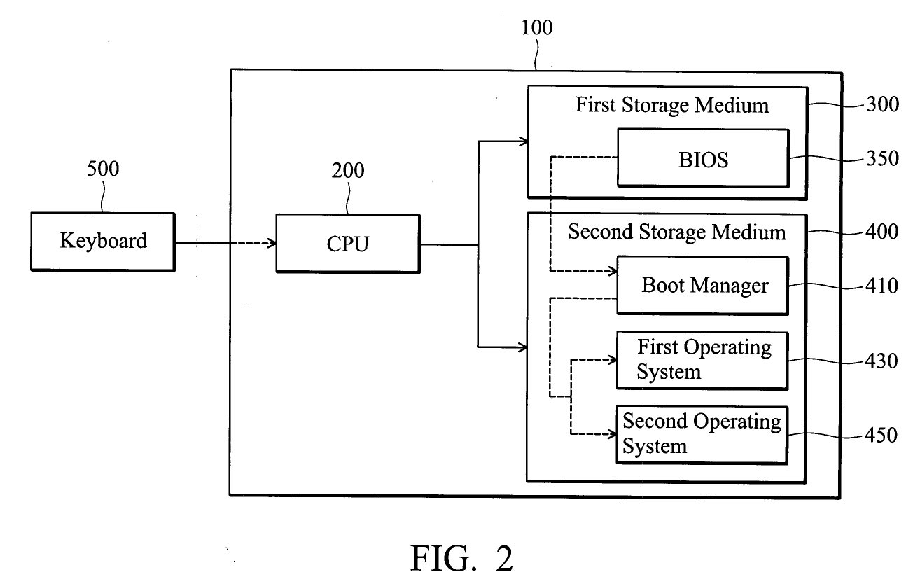

Several exemplary embodiments of the invention are described with reference to FIGS. 2 through 4, which generally relate to booting processes for instant-on computer systems. It is to be understood that the following disclosure provides many different embodiments as examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

FIG. 2 is a schematic diagram of an embodiment of an instant-on computer system.

A computer system 100 comprises a CPU 200, a first storage medium 300, and a second storage medium 400. First storage medium 300 stores BIOS 350. Second storage medium 400 stores a boot manager 410, a first operating system (Windows Operating System, for example) 430, and a second operating system (Linux Operating System, Tiny Windows Operating System, or embedded system, for example) 450. Additionally, a flag is defined and set as, for example, 0 and 1 to determine whether first operating system 430 or second operating system 450 is activated.

A quick key (not shown) located on a keyboard 500 is enabled to activate computer system 100 and CPU. 200 activates BIOS 350 stored in first storage medium 300. First storage medium 300 is generally a flash read only memory (Flash ROM). Next, BIOS 350 activates hardware peripherals of computer system 100 and CPU 200 loads and activates boot manager 410 stored in second storage. medium 400 through BIOS 350. In this embodiment, second storage medium 400 is generally a boot disk and boot manager is located into the cylinder 0, head 0, and sector 1 thereof. After access of BIOS 350, CPU 100 accesses boot manager 410 according to the master boot record (MBR) stored in the sector 1 of the boot disk.

Next, the quick key is enabled to trigger the defined flag. CPU 100 accesses the flag value and locates kernel codes of an operating system (first operating system 430 or second operating system 450) corresponding to flag value. CPU 100 loads the located kernel codes and executes a booting process corresponding to the operating system.

The flag can be located in storage medium 400 (the boot disk) or any other storage medium, and, if in the boot disk, is located into the cylinder 0, head 0, and sector 1 of the boot disk, as well as the MBR.

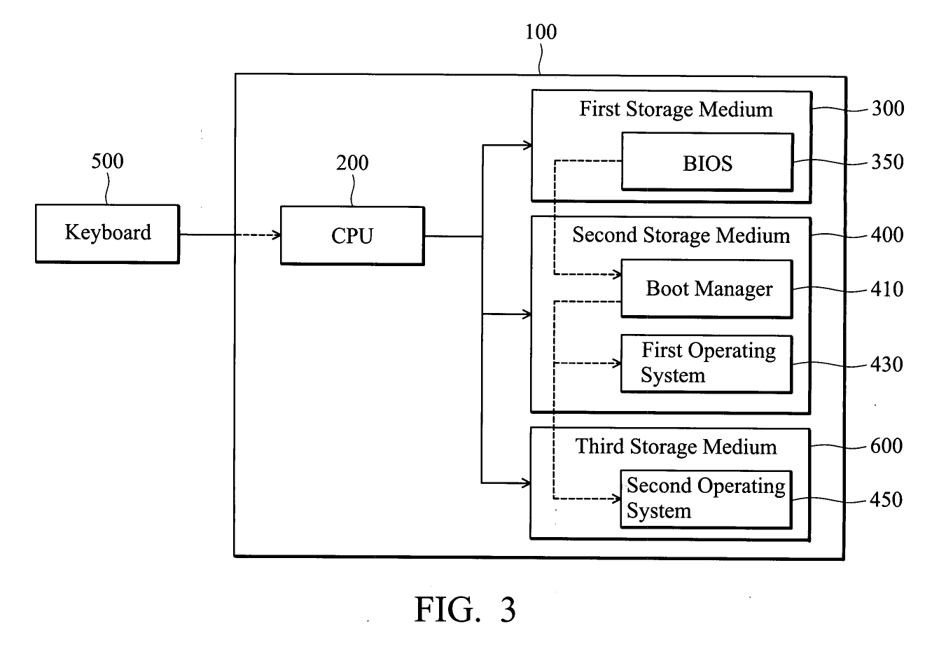

FIG. 3 is a schematic diagram of another embodiment of an instant-on computer system.

A computer system 100 comprises a CPU 200, a first storage medium 300, a second storage medium 400, and a third storage medium 600. First storage medium 300 stores BIOS 350. Second storage medium 400 stores a boot manager 410, and a first operating system (Windows Operating System, for example) 430. Third storage medium 600 stores a second operating system (Linux Operating System, Tiny Windows Operating System, or embedded system, for example) 450. The booting processing for computer system 100 shown in FIG. 3 is similar to that for the computer system shown in FIG. 2, in which the quick key is enabled to trigger the defined flag to activate first operating system 430 stored in second storage medium 400 or second operating system 450 stored in third storage medium 600.

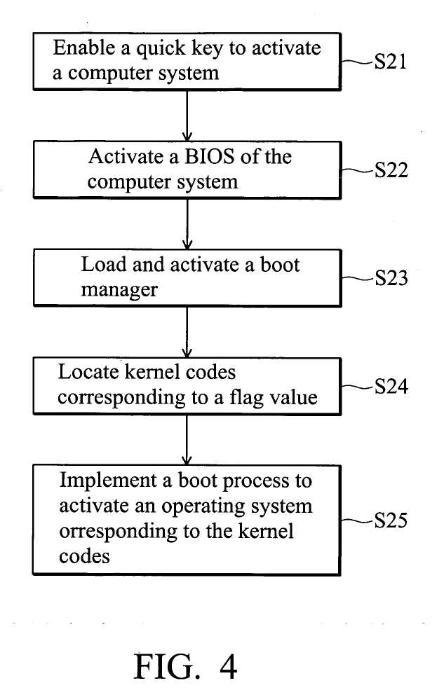

FIG. 4 is a flowchart of an embodiment of a method for instantly booting a computer system. The method for instantly booting a computer system of the invention is applied to a computer system, comprising at least one first storage medium, one second storage medium, and one third storage medium.

A quick key is enabled to activate the computer system and trigger a flag corresponding to the quick key (step S21). The BIOS of the computer system is implemented to activate hardware peripherals of the computer system (step S22). A boot manager stored in a storage medium (a hard disk, for example) is loaded and activated via the BIOS (step S23). Generally, the boot manager is located into the cylinder 0, head 0, and sector 1 of a boot disk. The boot manager locates kernel codes of a selected operating system corresponding to the triggered flag value and obtains kernel codes of a first operating system ((Windows Operating System, for example)), when the flag value equals to zero, or a second operating system (Linux Operating System, Tiny Windows Operating System, or embedded system, for example), when the flag value equals to one. (step S24) The kernel codes are loaded and a booting process corresponding thereto is implemented (step S25).

The booting method of the invention does not load a boot manager into a storage medium storing a BIOS, such that damage problems for the boot manager should not be concerned during BIOS update. When a BIOS update process is required, it can be implemented in a Windows operating system. The boot manager can be updated using an update program residing in a general operating system (Windows operating system, for example), convenient and resulting in less damage.

Further, the invention does not create a boot menu while a quick key is enabled for user selection, but loads kernel codes of a selected operating system corresponding to according to a predefined flag values corresponding to the quick key, saving booting time and achieving the purpose of “fast boot”.

Although the present invention has been described in preferred embodiment, it is not intended to limit the invention thereto. Those skilled in this technology can still make various alterations and modifications without departing from the scope and spirit of this invention. Therefore, the scope of the present invention shall be defined and protected by the following claims and their equivalents.

What is claimed is:

1. A method for instantly booting a computer system, comprising:
defining a flag for activation of a first operating system or a second operating system of the computer system;
enabling a quick key to activate the computer system;
activating a BIOS of the computer system;
loading and activating a boot manager via the BIOS; and
the boot manager triggering a flag according to the quick key and activating the first operating system or the second operating system corresponding to a flag value.

2. The method for instantly booting a computer system as claimed in claim 1, wherein the boot manager is stored into the cylinder 0, head 0, and sector 1 of a boot disk of the computer system.

3. The method for instantly booting a computer system as claimed in claim 2, wherein the flag is located ino the sector 1 of the boot disk.

4. The method for instantly booting a computer system as claimed in claim 1, wherein the boot manager locates kernel codes of the selected operating system according to the flag value and loads and executes the kernel codes to activate the selected operating system.

5. The method for instantly booting a computer system as claimed in claim 1, wherein the flag is located in a memory storing the BIOS.

6. An instant-on computer system, comprising:
a BIOS, capable of activating corresponding hardware peripherals when a quick key is enabled;
a first storage medium, capable of storing the BIOS;
a second storage medium, capable of storing a boot manager, a first operating system, and a second operating system; and
a CPU, capable of loading and activating the boot manager via the BIOS and triggering a flag via the boot manager according to the quick key to activate the first operating system or the second operating system corresponding to a flag value.

7. The computer system capable of an instant booting function as claimed in claim 6, wherein the second storage medium is a boot disk and the boot manager is stored into the cylinder 0, head 0, and sector 1 of the boot disk.

8. The computer system capable of an instant booting function as claimed in claim 7, wherein the flag is stored into the sector 1 of the boot disk.

9. The computer system capable of an instant booting function as claimed in claim 8, wherein the boot manager locates kernel codes of the first operating system, the second operating system, or a third-operating system according to the flag value and loads and executes the located kernel codes to activate a corresponding operating system.

10. An instant-on computer system, comprising:
a BIOS, capable of activating corresponding hardware peripherals when a quick key is enabled;
a first storage medium, capable of storing the BIOS;
a second storage medium, capable of storing a boot manager and a first operating system;
a third storage medium, capable of storing a second operating system; and
a CPU, capable of loading and activating the boot manager via the BIOS and triggering a flag via the boot manager according to the quick key to activate the first operating system or the second operating system corresponding to a flag value.
